(19) United States
(12) Patent Application Publication
(10) Pub. No.: US 2025/0196447 A1
(43) Pub. Date: Jun. 19, 2025

(54) LASER WELDING DEVICE

(71) Applicant: COAVIS, Sejong-si (KR)

(72) Inventors: Yonghwa HONG, Sejong-si (KR); Hyunduck JUNG, Chungcheongnam-do (KR); Hyuntae LEE, Sejong-si (KR)

(21) Appl. No.: 18/968,071

(22) Filed: Dec. 4, 2024

(30) Foreign Application Priority Data
Dec. 4, 2023 (KR) 10-2023-0173297

(51) Int. Cl. B29C 65/16; B29C 65/78; B29L 31/00

(52) U.S. Cl. CPC B29C 65/1635; B29C 65/1648; B29C 65/7855; B29L 2031/7496

(57) ABSTRACT

Provided is a laser welding device using a laser to fuse resin material parts to each other, and more particularly, a thermosetting resin laser welding device fixing a fusion target by using a transparent fixing member to perform fusion while a laser is emitted to an exact fusion point, and capable of emitting the laser to the fusion point by using a refraction of the laser even when an obstacle is present in a straight line between a laser light source and the fusion point.

### CROSS-REFERENCE TO RELATED APPLICATIONS

This application claims priority under 35 U.S.C. § 119 to Korean Patent Application No. 10-2023-0173297, filed on Dec. 4, 2023, in the Korean Intellectual Property Office, the disclosure of which is incorporated herein by reference in its entirety.

### TECHNICAL FIELD

The following disclosure relates to a laser welding device using a laser to fuse resin material parts to each other, and more particularly, to a resin laser welding device fixing a fusion target by using a transparent fixing member to perform fusion while a laser is emitted to an exact fusion point, and capable of emitting the laser to the fusion point by using a refraction of the laser even when an obstacle is present in a straight line between a laser light source and the fusion point.

### BACKGROUND

Polyphenylene sulfide (PPS), which is a type of thermosetting resin, is a new polymer material which may replace a metal in an automobile, an electrical or electronic product, and a machine due to its high strength and heat resistance, the new polymer material being able to withstand temperatures up to 250 degrees Celsius. PPS is light in weight and relatively inexpensive, and is thus highly cost-competitive among super engineering plastics. Therefore, PPS has a gradually expanding range of its usage, such as being used as a part material for precision equipment in a chemical plant, a semiconductor manufacturing process, or the like, a part material for an automobile pump, or a part material for reducing a weight of an electric vehicle or a hybrid vehicle.

Meanwhile, thermosetting resin such as PPS is not capable of being thermally fused when joining the parts to each other. Therefore, ultrasonic fusion or laser fusion may be considered. However, in a case of the ultrasonic fusion, a fusion intensity may be lower, airtightness may be poor, melted resin may flow out during the fusion to cause a burr occurring on the inside or outside of a joining surface, and it may be difficult to adjust an amount of fusion. Therefore, a technology for fusing thermosetting resins by using the laser has been recently announced.

FIGS. 1 and 2 show examples of the laser fusion in which the laser is emitted to a central resin part among three resin parts and the three parts are fuse-joined to one another by fusing the central resin layer.

As shown in FIG. 1, a fusion target 10 is disposed in which a first part 11 and a second part 12 are sequentially stacked in an opposite direction, and a laser light source 20 for the laser emission is disposed on one side of the fusion target 10. Here, the first part 11 may be formed as a laser-transmitting layer made of a light color that the laser transmits for the laser to be emitted to one surface of the second part 12, and the second part 12 may be formed as a non-laser-transmitting layer made of a dark color that the laser does not transmit. Therefore, when the laser is emitted thereto, the second part 12 may be fused by the laser to thus fuse-join the first and second parts 11 and 12 to each other.

Here, the light source 20 may be precisely set for the laser to be emitted to an exact fusion point between the first part 11 and the second part 12, i.e., for the laser to be emitted by a first distance L10 between the light source 20 and the fusion point. However, as the second part 12 is fused, its thickness may be reduced, and the fusion point between the first part 11 and the second part 12 may thus be gradually moved in the opposite direction, as shown in FIG. 2.

Therefore, a second distance L20 between the light source 20 and the fusion point may become longer than the first distance L10, and the laser may not exactly reach the fusion point, thus lowering a laser fusion quality.

### SUMMARY

An embodiment of the present disclosure is directed to providing a laser welding device including a fixing member that fixes a first part, which is a laser-transmitting layer, and a pressing member that presses a second part, which is a non-laser-transmitting layer, toward the first part, during laser fusion to thus maintain a consistent fusion point even when a thickness of the second part varies due to the fusion.

An embodiment of the present disclosure is also directed to providing a laser welding device including a refracting member disposed between a laser light source and a fusion point and refracting a laser for the laser to reach the fusion point even when an obstacle is disposed between the laser light source and the fusion point.

In one general aspect, provided is a laser welding device for fuse-joining the first part and second part of a fusion target, in which the fusion target includes the first part made of a laser-transmitting resin material and disposed on one side and the second part made of a non-laser-transmitting resin material and in contact with the other side of the first part, the device including: a laser light source disposed to be spaced apart from the one side of the fusion target and emitting a laser to one surface of the second part to fuse the second part; and a fixing member in contact with one surface of the first part and supporting one side of the first part, wherein the fixing member is made of a transparent material through which the laser is transmitted.

The device may further include a pressing member in contact with the other surface of the second part and supporting the other side of the second part, and including a pressing means for pressing the second part toward one side.

The fixing member may support the first part for the first part not to be moved toward the one side by the pressure of the pressing member applied toward the one side of the second part, and the pressing member may allow one surface of the second part to be in close contact with the other surface of the first part by pressing the second part toward the other side for a distance between the laser light source and the one surface of the second part not to be increased when a thickness of the second part is reduced due to the laser fusion.

The fusion target may further include a third part made of the non-laser-transmitting resin material, having one side in contact with the other side of the first part, and in contact with the one side or the other side of the second part in a width direction, and the laser welding device may emit the laser through the laser light source to one surface of each of the second part and the third part, where the second part and the third part are in contact with each other, to thus fuse the second part with the third part, thereby fuse-joining the first part to the third part.

The device may further include a pressing member in contact with the other surface of each of the second part and the third part and supporting the other side of each of the second part and the third part, and including a pressing means for pressing the second part and the third part toward the one side during the laser fusion.

The device, in which the other side of the second part is in contact with and supports a portion of the one side of the third part, may further include a pressing member in contact with the other surface of the third part and supporting the other side of the third part, and including a pressing means for pressing the third part toward the one side during the laser fusion.

The fixing member may support the first part for the first part not to be moved toward the one side by the pressure of the pressing member applied toward the one side of the third part, and the pressing member may allow the one surface of each of the second part and the third part to be in close contact with the other surface of the first part by pressing the third part to the other side for a distance between the laser light source and one surface of each of the second part and the third part not to be increased when thicknesses of the second part and the third part are reduced due to the laser fusion.

The fixing member may be made of quartz glass having heat and pressure resistance.

The first part may include a first body formed in a cylindrical shape and having one side closed and the other side open, and a first fusion part extending radially outward from a periphery of the other end of the first body, the third part may include a third body formed in a cylindrical shape and having the other side closed and one side open, and a third fusion part extending from one end of the third body to the one side and having one surface in contact with the other surface of the first fusion part, the second part may include a second body formed in a cylindrical shape and having an outer peripheral surface fitted into an inner peripheral surface of the third body, and a second fusion part extending from one end of the second body to one side and having one surface in contact with the other surface of the first fusion part and an outer peripheral surface in contact with an inner peripheral surface of the third fusion part, and the laser welding device may emit the laser to the one surface of each of the second fusion part and the third fusion part to thus fuse-join the one surface of each of the second and third fusion parts to the other surface of the first fusion part in a three-point manner.

The fixing member may include a fixing body having a through hole through which the first body passes to allow the other surface to be in contact with the first fusion part and support the first fusion part, the pressing member may include an accommodation body formed in a cylindrical shape to accommodate the third body and having one side open and the other side closed, and a pressing surface may be formed on one end of the accommodation body and in contact with the other surface of a flange extending radially outward from the one end of the third body.

The fixing member may include a protruding fixing member protruding from a radially inner side of the fixing body to the other side and having an end in contact with the first fusion part to support an area corresponding to a fusion point among the first to third fusion parts.

The fixing member may be fixed through a stage not to be moved toward one side or the other side while supporting the one side of the first part, and the stage may include a first stage on which the other surface of the fixing member in a radially outer direction is seated, and a second stage which is joined to a radially outer periphery of the first stage, and to which one surface of the fixing member in the radially outer direction is in contact with and fixed.

The laser welding device may emit the laser in circumferential directions of the second and third fusion parts by rotating the laser light source by 360 degrees while the laser light source is disposed at a center of the fusion target in an axial direction.

The device may further include a refracting member disposed between the light source and the first part for the laser to be refracted and emitted to the fusion point when the first body of the first part is disposed on a straight line between the light source and the fusion point.

The laser light source may emit the laser at a position spaced apart from the fusion point in the radially outer direction, and the emitted laser may be refracted by the refracting member and emitted to the fusion point without any interference with the first body.

The first part may be a motor housing of a water pump that accommodates a stator, the second part may be a rotor housing of the water pump that has one side joined to the first part, is accommodated in the third part, and accommodates an impeller and a rotor, and the third part may be a pump housing of the water pump that has one side joined to the first part, accommodates the second part, and accommodates the impeller.

Other features and aspects will be apparent from the following detailed description, the drawings, and the claims.

### BRIEF DESCRIPTION OF THE DRAWINGS

FIGS. 1 and 2 are schematic diagrams showing a laser fusion process using a conventional laser welding device.

FIG. 3 is a schematic diagram of a laser welding device according to a first embodiment of the present disclosure.

FIG. 4 is a schematic diagram showing a laser fusion process using the laser welding device according to the first embodiment of the present disclosure.

FIG. 5 is a schematic diagram of a laser welding device according to a second embodiment of the present disclosure.

FIG. 6 is a schematic diagram showing a laser fusion process using the laser welding device according to the second embodiment of the present disclosure.

FIG. 7 is a schematic diagram of a laser welding device according to a third embodiment of the present disclosure.

FIGS. 8 and 9 are enlarged schematic diagrams of a fusion part showing a laser fusion process using the laser welding device according to the third embodiment of the present disclosure.

FIG. 10 is a schematic diagram of a laser welding device according to a fourth embodiment of the present disclosure.

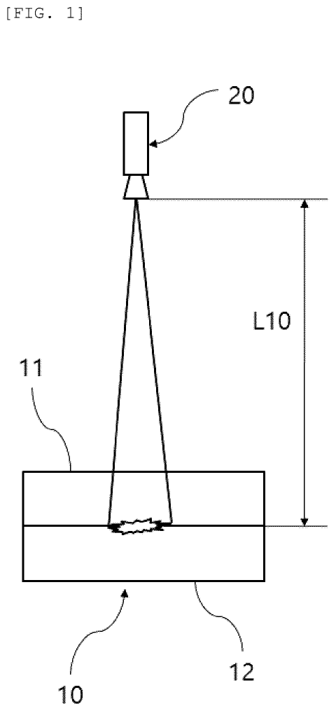

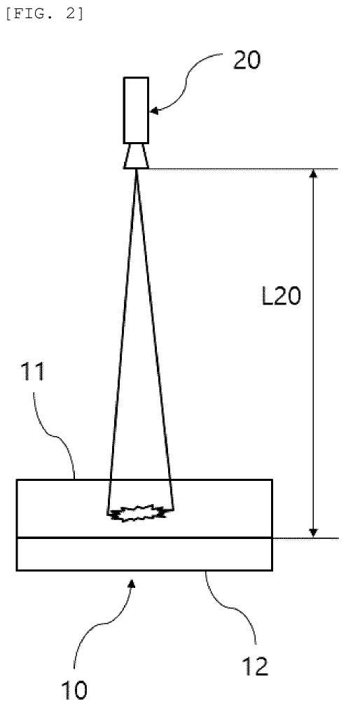

### DETAILED DESCRIPTION OF EMBODIMENTS

Hereinafter, an embodiment of the present disclosure is described in detail with reference to the accompanying drawings.

### First Embodiment (2-Point Fusion Example)

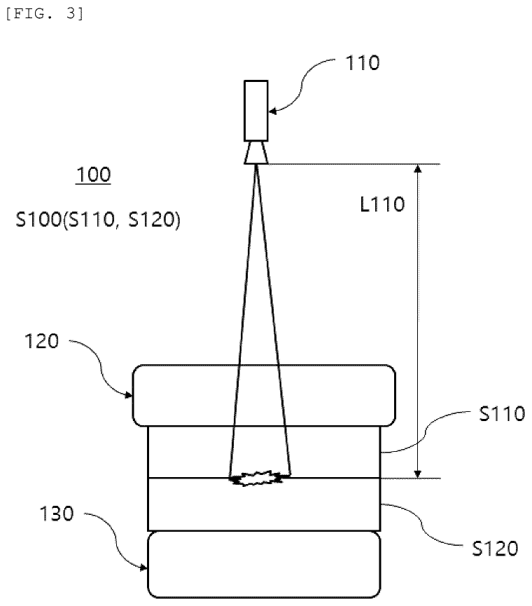

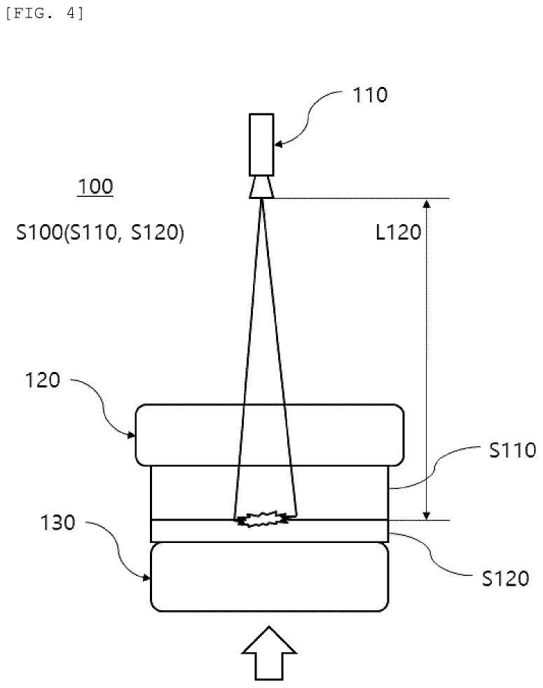

FIG. 3 is a schematic diagram showing a laser welding device 100 according to the first embodiment of the present disclosure, and FIG. 4 is a schematic diagram showing a laser fusion process using the laser welding device 100 according to the first embodiment of the present disclosure.

For convenience, an upper side of the drawing is defined as one side and its lower side is defined as the other side. The laser welding device 100 for performing laser fusion-joining on a fusion target S100, which includes a first part S110 made of a laser-transmitting layer and disposed on one side and a second part S120 made of a non-laser-transmitting layer and disposed on the other side, may include a laser light source 110 disposed to be spaced apart from one side of the fusion target S100, a fixing member 120 in contact with one surface of the first part S110 and supporting and fixing one side of the first part S110, and a pressing member 130 in contact with the other surface of the second part S120 and supporting the other side of the second part S120 and including a pressing means for pressing the second part S120 toward one side during laser fusion. The pressing means may be an actuator using conventional pneumatic or hydraulic pressure or an actuator using a rotational power of an electric motor.

Here, the fixing member 120 may be made of a transparent material through which the laser is transmitted, and for example, may be made of glass. In more detail, the fixing member 120 may be made of quartz glass, which is resistant to deformation or bubble formation caused by heat and pressure in the laser fusion process.

The laser fusion machine 100 configured as above may have the second part S120 whose thickness is reduced when fused by laser emission. Here, as the other end of the second part S120 is pressed toward one side by the pressing member 130, the first part S110 and the second part S120 may maintain their close contact state rather than being moved toward the other side. In addition, one side of the first part S110 may be supported by the fixing member 120 to ensure that a fusion point between the first part S110 and the second part S120 is not moved toward one side even when pressed by the pressing member 130.

Therefore, the laser welding device 100 may maintain the constant fusion point between the first part S110 and the second part S120 by the fixing member 120 and the pressing member 130 instead of being moved toward the other side even when the thickness of the second part S120 is reduced.

That is, a first distance L110 between the light source 110 and one surface of the second part S120 before the fusion, as shown in FIG. 3, and a second distance L120 between the light source 110 and one surface of the second part S120 in a state where the thickness of the second part S120 is reduced as the fusion progresses, as shown in FIG. 4, may be maintained to be the same as each other.

Meanwhile, if the laser welding device 100 according to an embodiment of the present disclosure has one side as its lower side and the other side as its upper side, the second part S120 may be pressed toward one side by its own weight. Therefore, the second distance L120 between the light source 110 and one surface of the second part S120 may be maintained to be the same even when the thickness of the second part S120 is reduced without any pressing means.

### Second Embodiment 2 (3-Point Fusion Example)

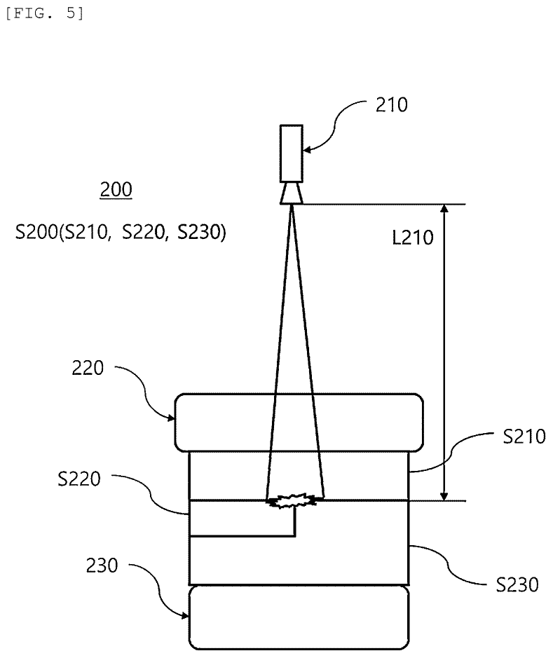

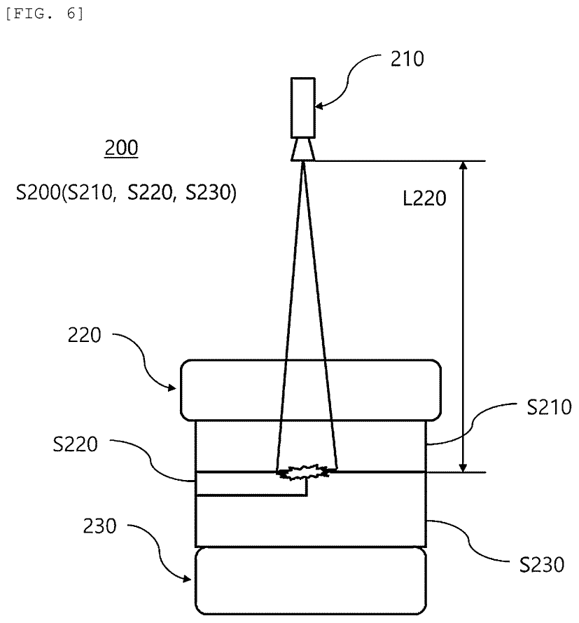

FIG. 5 is a schematic diagram showing a laser welding device 200 according to the second embodiment of the present disclosure, and FIG. 6 is a schematic diagram showing a laser fusion process using the laser welding device 200 according to the second embodiment of the present disclosure.

For convenience, the upper side of the drawing is defined as one side and its lower side is defined as the other side. The laser welding device 200 according to this embodiment may perform three-point laser fusion-joining on a fusion target S200, which includes a first part S210 made of a laser-transmitting layer and disposed on one side, a second part S220 made of a non-laser-transmitting layer and disposed on the other side of the first part S210, and a third part S230 made of the non-laser-transmitting layer and disposed on the other side of the first part S210 adjacent to the second part S220.

The laser welding device 200 may include a laser light source 210 disposed to be spaced apart from one side of the fusion target S200, a fixing member 220 in contact with one surface of the first part S210 and supporting and fixing one side of the first part S210, and a pressing member 230 in contact with the other surface of the third part S230 and supporting the other side of the third part S230 and including a pressing means for pressing the second part S220 and the third part S230 toward one side during the laser fusion.

In the drawing, the other side of the second part S220 is shown as being in contact with the other surface of the first part S210 while being seated on a portion of one surface of the third part S230. However, in another embodiment, the second part S220 may be disposed to be adjacent to the third part S230, and have one side in contact with the other surface of the first part S210, and the other side in contact with one surface of the pressing member 230.

Here, the fixing member 220 may be made of a transparent material through which the laser is transmitted, and for example, may be made of glass. In more detail, the fixing member 220 may be made of quartz glass, which is resistant to deformation or bubble formation caused by heat and pressure in the laser fusion process.

The laser welding device 200 configured as above may emit the laser through the light source 210 to an area on one surface of each of the second part S220 and the third part S230, where the second part S220 and the third part S230 are in contact with each other, to thus fuse the second part S220 with the third part S230, thereby causing the first to third parts S210, S220, and S230 to be fuse-joined at three points. Here, the thicknesses of the second part S220 and the third part S230 may be reduced due to the fusion. Here, as the other end of the third part S230 is pressed toward one side by the pressing member 230, the first part S210 and the second part S220 as well as the first part S210 and the third part S230 may maintain their close contact state rather than the first part S210 to the third part S230 being moved toward the other side. In addition, one side of the first part S210 may be supported by the fixing member 220 to ensure that a fusion point among the first part S210, the second part S220 and the third part S230 is not moved toward one side even when pressed by the pressing member 230.

Therefore, the laser welding device 200 may maintain the constant fusion point among the first part S210, the second part S220 and the third part S230 by the fixing member 220 and the pressing member 230 instead of being moved toward the other side even when the thicknesses of the second part S220 and the third part S230 are reduced.

That is, a first distance L210 between the light source 210 and one surface of each of the second part S220 and the third part 230 before the fusion, as shown in FIG. 5, and a second distance L220 between the light source 210 and one surface of the second part S220 or the third part S230 in a state where the thicknesses of the second part S220 and the third part S230 are reduced as the fusion progresses, as shown in FIG. 6, may be maintained to be the same as each other.

### Third Embodiment (Water Pump Case Fusion Example)

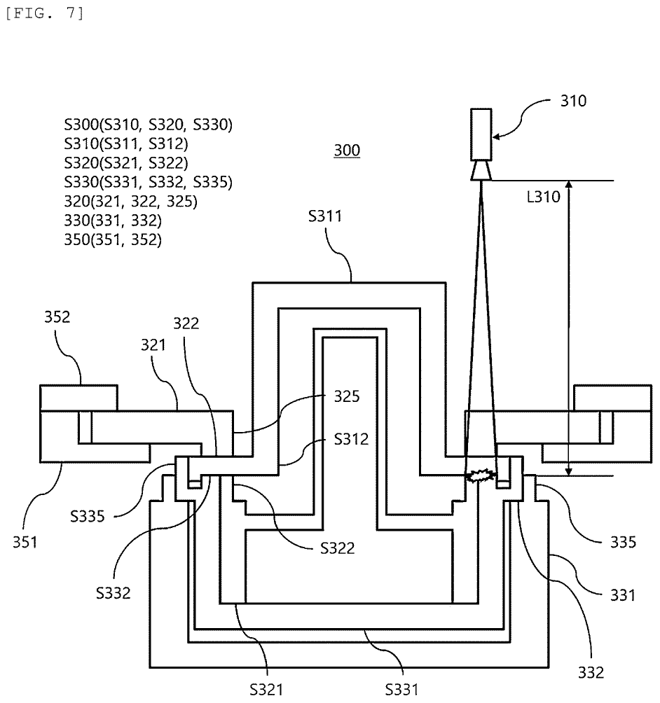

FIG. 7 shows a schematic diagram of a laser welding device 300 according to the third embodiment of the present disclosure.

For convenience, the upper side of the drawing is defined as one side and its lower side is defined as the other side.

The laser welding device 300 according to this embodiment may perform the fusion on a fusion target S300, which includes a first part S310 made of a laser-transmitting layer and disposed on one side, a second part S320 made of a non-laser-transmitting layer and disposed on the other side of the first part S310, and a third part S330 made of the non-laser-transmitting layer and disposed on the other side of the second part S320. The fusion target S300 may be, for example, a water pump case for a vehicle.

Therefore, the first part S310 may be a motor housing of a water pump, and the motor housing may accommodate a stator, which is a component of the water pump. To this end, the first part S310 may include a first body S311 formed in a cylindrical shape and having one side closed and the other side open, and a first fusion part S312 extending radially outward from a periphery of the other end of the first body S311.

In addition, the second part S320 may be a rotor housing of the water pump, and have one side joined to the first part S310 and the other side accommodated in the third part S330. The second part S320 may accommodate a portion of an impeller and a rotor, which are components of the water pump. To this end, the second part S320 may include a second body S321 formed in a cylindrical shape and having an outer peripheral surface fitted into an inner surface of a third body S331 of the third part S330, and a second fusion part S322 extending from one end of the second body S322 to one side. The second fusion part S322 may have one surface in contact with the other surface of the first fusion part S312 and an outer peripheral surface in contact with an inner peripheral surface of a third fusion part S332 for its three-point fusion-joining with the first fusion part S312 and the third fusion part S332 described below.

In addition, the third part S330 may be a pump housing of the water pump, and have an impeller accommodation space for accommodating the impeller, which is formed by being joined with the second part S310. In detail, the first part S310 may be joined to one side of the third part S330, and the second part S320 may be inserted into the first part S310 to thus form a space therein.

To this end, the third part S330 may include the third body S331 formed in a cylindrical shape and having the other side closed and one side open, and the third fusion part S332 extending from one end of the third body S331 to one side. The second part S320 may be joined to an inner peripheral surface of the third body S331 for the inner peripheral surface of the third body S331 to be in contact with an outer peripheral surface of the second body S321 as described above. The third fusion part S332 may have one surface in contact with the other surface of the first fusion part S312 for its three-point fusion-joining with the first fusion part S312 and the second fusion part S322, and have the inner peripheral surface in contact with the outer peripheral surface of the second fusion part S322.

Therefore, one surface of the second fusion part S322 and that of the third fusion part S332 may be fused to each other by the emission of the laser that transmits the first fusion part S312, and the first to third fusion parts S312, S322, and S332 may thus be fuse-joined with one another.

The laser welding device 300 for performing the laser fusion-joining on the fusion target S300, which is the water pump case configured as above, may include a laser light source 310 disposed to be spaced apart from one side of the fusion target S300, a fixing member 320 in contact with one surface of the first fusion part S312 of the first part S310 and supporting and fixing one side of the first part S310, and a pressing member 330 in contact with the other surface of the third part S330 and supporting the other side of the third part S330, and including a pressing means for pressing the third part S330 toward one side during the laser fusion.

In more detail, the fixing member 320 may include a ring-shaped fixing body 321 having a through hole 325 through which a first body S311 passes for the other surface to be in contact with a first fusion part S312. Therefore, the other surface of the fixing body 321 may have a radially inner side in contact with one surface of the first fusion part S312 and supporting one side of the first part S310. In addition, the fixing member 320 may include a protruding fixing member 322 protruding radially inward to the other side from the other surface where the fixing body 321 and the first fusion part S312 are in contact with each other. That is, the other surface of the protruding fixing member 322 may be in contact with the first fusion part S312. In more detail, the protruding fixing member 322 may protrude from an area corresponding to the fusion point where the first to third fusion parts S312, S322, and S332 are fused with one another.

The protruding fixing member 322 may more effectively prevent the second part and the third part S320 and S330 from being moved toward one side when thicknesses of the second fusion part and the third fusion part S322 and S332 are reduced due to the fusion.

Meanwhile, the fixing member 320 may be fixed through a stage 350 not to be moved toward one side or the other side while supporting one side of the first part S310. The stage 350 may include a first stage 351 on which the other surface of the fixed member 320 in a radially outer direction is seated, and a second stage 352 which is joined to one surface of the first stage 351 and to which one surface of the fixed member 320 in the radially outer direction is in contact with and fixed.

In addition, the fixing member 320 may be made of a transparent material through which the laser is transmitted, and for example, may be made of glass. In more detail, the fixing member 320 may be made of quartz glass, which is resistant to deformation or bubble formation caused by heat and pressure in the laser fusion process.

The pressing member 330 may include an accommodation body 331 formed in a cylindrical shape to accommodate the third body S331 of the third part S330 and having one side open and the other side closed. A pressing surface 332 may be formed on one end of the accommodation body 331, and be in contact with a periphery of one side of the third body S331.

In addition, the third body S331 may include a fixing jaw 335 extending from the pressing surface 332 toward one side to prevent the third part S330 from being moved radially outward when the third body S331 is pressed toward the other side while the third part S330 is in a seated state. Therefore, one outer peripheral surface of the third fusion part S332 may be in contact with an inner peripheral surface of the fixing jaw 335.

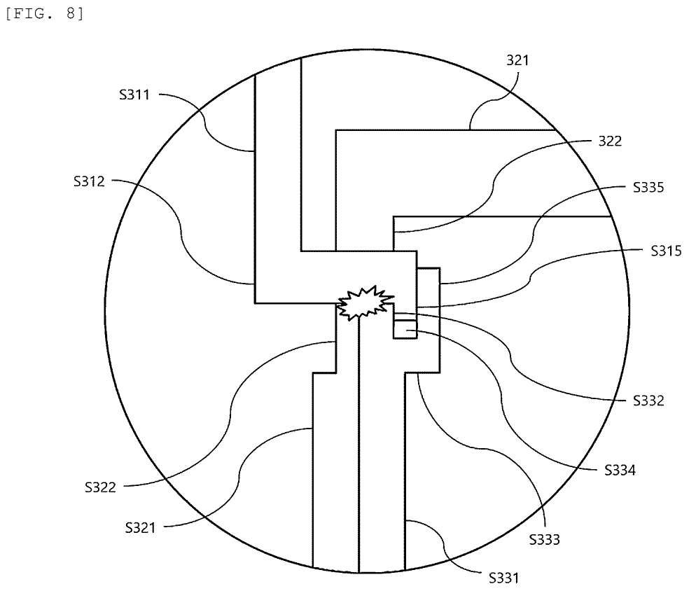

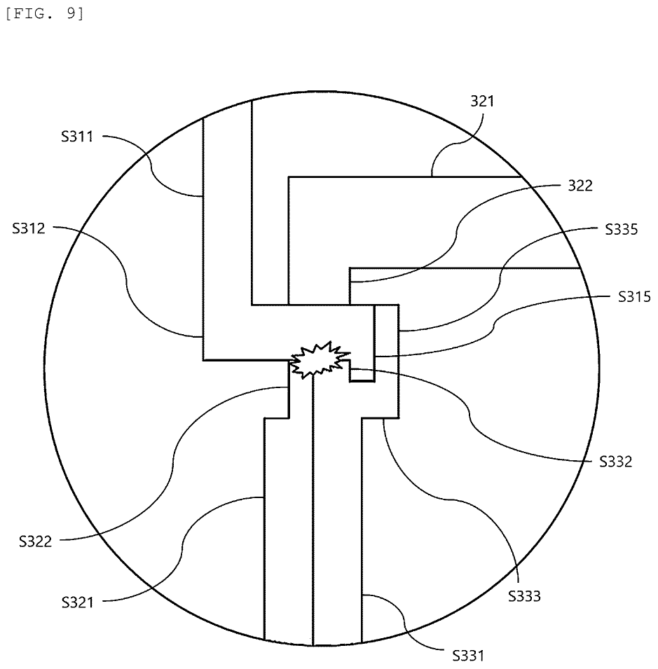

FIGS. 8 and 9 are enlarged schematic diagrams of the fusion part showing the laser fusion process using the laser welding device 300 according to the third embodiment of the present disclosure.

The third part S330 may further include a flange S333 extending radially outward from one end of the third body S331. The third fusion part S332 may protrude to one side from an inner side of the flange S333 in a radial direction, and a joining jaw S335 may protrude to one side from the other side of the flange S333 in the radial direction for its inner peripheral surface to be in contact with an outer peripheral surface of the first fusion part S312.

The third fusion part S332 and the joining jaw S335 may be spaced apart from each other by a predetermined distance, and a joining groove S334 may be formed between the third fusion part S332 and the joining jaw S335. A joining projection S315 protruding to the other side from a radially outer end of the first fusion part S312 may be fitted into the joining groove S334.

The pressing surface 332 of the pressing member 330 described above may be in contact with the other surface of the flange S333 in the radially outer direction to thus support the third part S330 upward by the pressure of the pressing member 330.

The laser welding device 300 configured as described above may have the second and third fusion parts S322 and S332 whose thicknesses are reduced as shown in FIG. 9 when the second and third fusion parts S322 and S332 are fused to each other by the laser emission. Here, as the third part S330 is pressed toward one side by the pressing member 330, the first to third fusion parts S312, S322, and S332 may maintain their close contact state rather than the second part S320 and the third part S330 being moved toward the other side.

In addition, one side of the first fusion part S312 may be supported by the fixing body 321 and the protruding fixing member 322 for the fusion point among the first to third fusion parts S312, S322, and S332 not to be moved toward one side even when pressed by the pressing member 330.

Therefore, the laser welding device 300 may maintain the constant fusion point among the first to third fusion parts S312, S322, and S332 by the fixing member 320 and the pressing member 330 instead of being moved toward the other side even when the thicknesses of the second and third parts S322 and S333 are reduced.

That is, a third distance L310 between the light source 310 and the fusion point, as shown in FIG. 7, may be maintained to be the same during the fusion process.

### Fourth Embodiment (Laser Refractive Type)

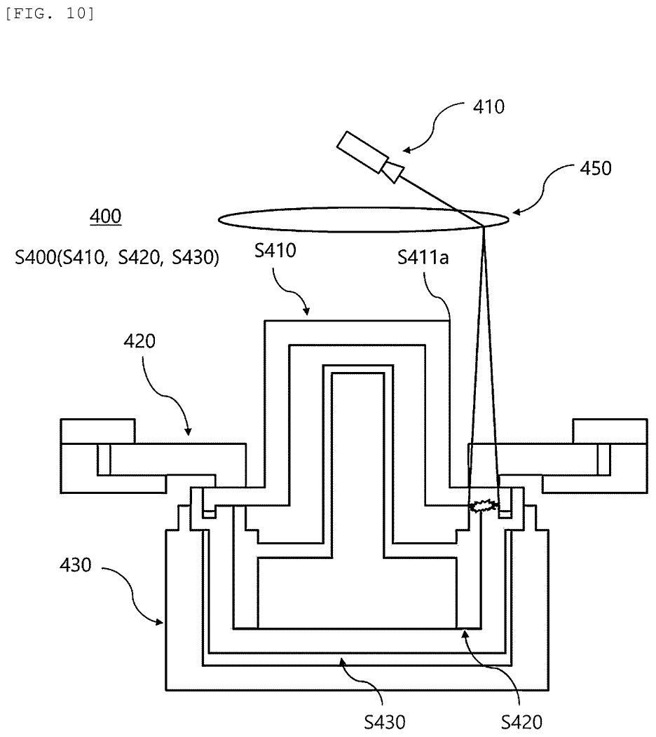

FIG. 10 shows a schematic diagram of a laser welding device 400 according to the fourth embodiment of the present disclosure.

For convenience, the upper side of the drawing is defined as one side and its lower side is defined as the other side.

The fusion target S400 may include a first part S410 made of the laser-transmitting layer and disposed on one side, a second part S420 made of the non-laser-transmitting layer and disposed on the other side of the first part S410, and a third part S430 made of the non-laser-transmitting layer, disposed on the other side of the first part S410, and accommodating the second part S420. The fusion target S400 is the same as the fusion target S300 in the third embodiment described above.

The laser welding device 400 for performing the laser fusion-joining on the fusion target S400 described as above may include a laser light source 410 disposed to be spaced apart from one side of the fusion target S400, a fixing member 420 in contact with one surface of the first part S410 and supporting and fixing one side of the first part S410, and a pressing member 430 in contact with the other surface of the third part S430 and supporting the other side of the third part S430, and including a pressing means for pressing third part S430 toward one side during the laser fusion.

Meanwhile, the laser fusion may be performed in circumferential directions of the first to third fusion parts S312, S322, and S332 (see FIG. 7). To this end, the fusion may be performed by fixing the fusion target S400 and rotating the light source by 360 degrees while the light source is disposed at the center of the fusion target S400 in an axial direction, or by fixing the light source and rotating the fusion target S400 by 360 degrees. Here, the fusion target S400 may be fixed and supported by the pressing member 430. Therefore, in this embodiment, a method of rotating the fusion target S400 may result in a complicated structure, and if the method is not precisely controlled, the laser may not be emitted to the accurate fusion point. Therefore, in this embodiment, a method of rotating the light source may be preferable. However, when using this method, an upper periphery S411a of the first body of the first part S410 may be disposed on a straight line between the light source 410 and the fusion point, thus preventing the laser from reaching the fusion point. Laser intensity needs to be increased further to allow the laser to reach the fusion point.

Therefore, the laser welding device 400 according to the fourth embodiment of the present disclosure may further include the following configuration. The laser welding device 400 in the present disclosure may further include a refracting member 450 refracting the laser emitted from the light source 410. The refracting member 450 may be disposed between the light source 410 and the first part S410 and refract the laser emitted from the light source 410 radially inward and emit the same to the fusion point. Therefore, the refracting member 450 may be a convex lens. Therefore, while the light source 410 is disposed in the axial direction of the fusion target S400, the laser may be emitted to the fusion point at an angle that is increased radially outward from the straight line between the light source 410 and the fusion point, and then refracted by the refracting member 450. As a result, the laser may be emitted to the fusion point without any interference with the upper periphery S411a of the first body of the first part S410.

The laser welding device 400 in the embodiment described above may perform the fusion by rotating the light source to thus have a simple structure and improve fusion precision, and may perform the fusion without adjusting the laser intensity even when the obstacle is disposed on the straight line between the light source and the fusion point.

As set forth above, the laser welding device in the present disclosure configured as above may improve a fusion quality as the fusion point is maintained at a constant level even when the thickness of the fuse layer is reduced by the laser fusion.

In addition, the laser welding device in the present disclosure may perform the laser fusion without changing a fusion layout, such as changing a position of the light source because the laser is emitted to the fusion point even when the obstacle is disposed between the light source and the fusion point due to the structure or shape of the fusion target.

The spirit of the present disclosure should not be limited to an embodiment described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A laser welding device for fuse-joining the first part and second part of a fusion target, in which the fusion target includes the first part made of a laser-transmitting resin material and disposed on one side and the second part made of a non-laser-transmitting resin material and in contact with the other side of the first part, the device comprising:
a laser light source disposed to be spaced apart from the one side of the fusion target and emitting a laser to one surface of the second part to fuse the second part; and
a fixing member in contact with one surface of the first part and supporting one side of the first part,
wherein the fixing member is made of a transparent material through which the laser is transmitted.

2. The device of claim 1, further comprising a pressing member in contact with the other surface of the second part and supporting the other side of the second part, and including a pressing means for pressing the second part toward one side.

3. The device of claim 2, wherein the fixing member supports the first part for the first part not to be moved toward the one side by the pressure of the pressing member applied toward the one side of the second part, and
the pressing member allows one surface of the second part to be in close contact with the other surface of the first part by pressing the second part toward the other side for a distance between the laser light source and the one surface of the second part not to be increased when a thickness of the second part is reduced due to the laser fusion.

4. The device of claim 1, wherein the fusion target further includes a third part made of the non-laser-transmitting resin material, having one side in contact with the other side of the first part, and in contact with the one side or the other side of the second part in a width direction, and
the laser welding device emits the laser through the laser light source to one surface of each of the second part and the third part, where the second part and the third part are in contact with each other, to thus fuse the second part with the third part, thereby fuse-joining the first part to the third part.

5. The device of claim 4, further comprising a pressing member in contact with the other surface of each of the second part and the third part and supporting the other side of each of the second part and the third part, and including a pressing means for pressing the second part and the third part toward the one side during the laser fusion.

6. The device of claim 4, in which the other side of the second part is in contact with and supports a portion of the one side of the third part, the device further comprising a pressing member in contact with the other surface of the third part and supporting the other side of the third part, and including a pressing means for pressing the third part toward the one side during the laser fusion.

7. The device of claim 6, wherein the fixing member supports the first part for the first part not to be moved toward the one side by the pressure of the pressing member applied toward the one side of the third part, and
the pressing member allows the one surface of each of the second part and the third part to be in close contact with the other surface of the first part by pressing the third part to the other side for a distance between the laser light source and one surface of each of the second part and the third part not to be increased when thicknesses of the second part and the third part are reduced due to the laser fusion.

8. The device of claim 4, wherein the fixing member is made of quartz glass having heat and pressure resistance.

9. The device of claim 6, wherein the first part includes a first body formed in a cylindrical shape and having one side closed and the other side open, and a first fusion part extending radially outward from a periphery of the other end of the first body,
the third part includes a third body formed in a cylindrical shape and having the other side closed and one side open, and a third fusion part extending from one end of the third body to the one side and having one surface in contact with the other surface of the first fusion part,
the second part includes a second body formed in a cylindrical shape and having an outer peripheral surface fitted into an inner peripheral surface of the third body, and a second fusion part extending from one end of the second body to one side and having one surface in contact with the other surface of the first fusion part and an outer peripheral surface in contact with an inner peripheral surface of the third fusion part, and
the laser welding device emits the laser to the one surface of each of the second fusion part and the third fusion part to thus fuse-join the one surface of each of the second and third fusion parts to the other surface of the first fusion part in a three-point manner.

10. The device of claim 9, wherein the fixing member includes a fixing body having a through hole through which the first body passes to allow the other surface to be in contact with the first fusion part and support the first fusion part,
the pressing member includes an accommodation body formed in a cylindrical shape to accommodate the third body and having one side open and the other side closed, and a pressing surface is formed on one end of the accommodation body and in contact with the other surface of a flange extending radially outward from the one end of the third body.

11. The device of claim 9, wherein the fixing member includes a protruding fixing member protruding from a radially inner side of the fixing body to the other side and having an end in contact with the first fusion part to support an area corresponding to a fusion point among the first to third fusion parts.

12. The device of claim 4, wherein the fixing member is fixed through a stage not to be moved toward one side or the other side while supporting the one side of the first part, and
the stage includes
a first stage on which the other surface of the fixing member in a radially outer direction is seated, and a second stage which is joined to a radially outer periphery of the first stage, and to which one surface of the fixing member in the radially outer direction is in contact with and fixed.

13. The device of claim 9, wherein the laser welding device emits the laser in circumferential directions of the second and third fusion parts by rotating the laser light source by 360 degrees while the laser light source is disposed at a center of the fusion target in an axial direction.

14. The device of claim 13, further comprising a refracting member disposed between the light source and the first part for the laser to be refracted and emitted to the fusion point when the first body of the first part is disposed on a straight line between the light source and the fusion point.

15. The device of claim 14, wherein the laser light source emits the laser at a position spaced apart from the fusion point in the radially outer direction, and the emitted laser is refracted by the refracting member and emitted to the fusion point without any interference with the first body.

16. The device of claim 8, wherein the first part is a motor housing of a water pump that accommodates a stator,
the second part is a rotor housing of the water pump that has one side joined to the first part, is accommodated in the third part, and accommodates an impeller and a rotor, and
the third part is a pump housing of the water pump that has one side joined to the first part, accommodates the second part, and accommodates the impeller.
